(19) United States
(12) Patent Application Publication
(10) Pub. No.: US 2025/0133637 A1
(43) Pub. Date: Apr. 24, 2025

(54) METHOD FOR TEMPERATURE COMPENSATION FOR COMPACT LED LIGHTS

(71) Applicant: Melexis Technologies NV, Tessenderlo (BE)

(72) Inventor: Raik FROST, Erfurt (DE)

(21) Appl. No.: 18/905,861

(22) Filed: Oct. 3, 2024

(30) Foreign Application Priority Data
Oct. 20, 2023 (EP) 23204922.1

(51) Int. Cl. H05B 45/28

(52) U.S. Cl. CPC H05B 45/28

(57) ABSTRACT

A method and an apparatus for temperature compensation are described. The method includes receiving a target color point for light emitted by at least one light-emitting device, determining an operating electrical energy of the at least one light-emitting device based on a correlation of at least one temperature value of the at least one light-emitting device with the received target-color point and operating the at least one light-emitting device based on the determined operating electrical energy.

### TECHNICAL FIELD

The invention is related to a method for temperature compensation of a light-emitting device, in particular for temperature compensation of a light-emitting diode, LED.

### BACKGROUND

Today, more and more lighting tasks are fulfilled by LED technology. This is not only due to the improved energy efficiency and the lower thermal heating, but also because of the improved brightness, the lesser required mounting space, and the improved lifetime.

For example, in modern automobiles, front- and rear-lights are already frequently realized using LED technology. Similarly, interior lights within the car itself are often implemented using LEDs as, e.g., signal lamps. However, not only the automobile industry makes use of LED technology, but also other domains of technology and engineering where lighting with a given brightness and a desired color is required. For example, modern architecture uses the potential of LED lighting to implement daylight-adapted lighting schemes, for which color and brightness are steered dynamically in response to the daylight conditions outside of a building. However, also several other applications of LED technology are contemplated.

To steer the brightness and the color of a lighting device as desired, a lighting device may include a plurality of different light-emitting devices of different colors, which emit light that is mixed to yield light having the desired brightness and color. Each of the plurality of light-emitting devices can also be referred to as light-emitting components. For example, a typical lighting device may include a red, a green and a blue LED, and the electrical energy supplied to the red, green and blue LED are adjusted such that the superposition of the light emitted by the LEDs features the desired brightness and color. However, a lighting device may also include only one light-emitting device which can be driven differently to emit light of varying color and brightness, e.g., an organic LED, OLED. In this case, one light-emitting device may comprise several light-emitting components, each of which is configured to emit light at a different wavelength.

Unfortunately, there is a conflict between steering the brightness at the same time as the color of light emitted from a lighting device. Depending on which brightness is chosen, the lighting device heats up in different ways and as such alters the color which is emitted. For example, if the lighting device is driven in a high-brightness mode, it heats up more than when driven in a low-brightness mode. However, when the temperature of a lighting device changes, the color of the lighting device changes, too. This effect can already be observed for traditional light bulb, which emits whiter light the more its filament is heated up. Similarly, the color of an LED depends on its temperature. Thus, if the brightness of a lighting device is changed, the color of the resulting light changes, too.

In order to hold the brightness and color of a lighting device steady, there exist a need in the art to compensate the influences the heat has on the respective light-emitting devices of the lightning device.

### SUMMARY

This need is fulfilled by the method for temperature compensation and the corresponding apparatus.

The temperature compensation method according to the invention comprises receiving a target color point for light emitted by at least one light-emitting device of a lighting device.

The target color point may thereby be a value, e.g. a specific wavelength λ, and/or frequency, v, the at least one light-emitting device shall emit. It is called a target color point, since it is the target of the at least one light-emitting device to reach the defined color under all circumstances, e.g. irrespectively of the ambient temperature and/or the temperature of the at least one light-emitting device itself. Thereby, any light emitted by the at least one light-emitting device may be characterized by its spectral radiance, i.e., by the relative distribution of radiant power as a function of the light wavelength, A. As is known in the art, numerous RGB color spaces can be defined, which have in common that a given perceived color is fully described by three Tristimulus values, X, Y and Z. Three values arise since the human eye contains three types of cone cells (S, L, M) responsible for photoreception, which leads to trichromatic color vision. Typical examples of RGB color spaces are CIE RGB, CIE XYZ, NTSC and PAL/SECAM. More recent examples of RGB color spaces are DCI-P3, UHDTV and RIMM/ROMM. Each of the three colors of the RGB color space may be given by one light-emitting device. For example, one light-emitting device may emit predominantly a wavelength which is associated with a red color, one light emitting device may emit predominantly a wavelength which is associated with a green color, and another light-emitting device may emit predominantly a wavelength which is associated with a blue color. The superposition of the respective colors then provides a perceptible color for the human eye. The three Tristimulus values X, Y, Z of the RGB color space describe the color of emitted light and are obtained by integrating, over the wavelength, the spectral radiance of the emitted light multiplied by the respective of the three spectral sensitivity curves x(λ), y(λ) and z(λ) of the CIE standard observer. It could also be said that the Tristimulus values X, Y and Z for a given stream of emitted light are obtained by projecting the spectral radiance of the emitted light on each of the three spectral sensitivity curves x(λ), y(λ) and z(λ) of the CIE standard observer. In this way, each individual color state of light emitted by a light-emitting device is characterized by another three-dimensional vector of Tristimulus values X, Y and Z. Hence, if a target color point is set, it can also be said that the Tristimulus values X, Y and Z are given, which define a specific color the light-emitting device shall reach. The color Tristimulus values X, Y and Z are also related to the brightness, which is given as the absolute value of the vector made out of the Tristimulus values. As such, it can also be said that the target color point is related or associated with a target brightness. Hence, it is also possible that the received target color point comprises a brightness of the light emitted by the at least one light-emitting device.

For simplicity, in the following when it is referred to the RGB components, red, green and blue also the respective Tristimulus values X, Y and Z values are meant and vice versa. This is due to the fact that the values can be transformed into one another. In the following, if not explicitly stated otherwise, the Tristimulus values X, Y and Z are equated with the RGB colors, since the Tristimulus values X, Y and Z can be transformed into the RGB colors and vice versa.

$$[ \begin{matrix}X \\ Y \\ Z\end{matrix} ] = M [ \begin{matrix}r \\ g \\ b\end{matrix} ] or [ \begin{matrix}r \\ g \\ b\end{matrix} ] = {M}^{- 1} [ \begin{matrix}X \\ Y \\ Z\end{matrix} ]$$

Thereby, the X value relates to red, the Y value represents the luminance, and the Z value relates to the blue and M relates to a matrix transformation between the two components.

The method for temperature compensation further comprises determining an operating electrical energy of the at least one light-emitting device based on a correlation of at least one temperature value of the at least one light-emitting device with the received target color point.

If the target color point is set, then the electrical energy which needs to be applied to the at least one light-emitting device can be determined based on a mathematical correlation between the temperature of the at least one light-emitting device, the current electrical energy applied to the at least one light-emitting device, and the target color point. In other words, based on the knowledge of the temperature of the at least one light-emitting device and the target color point, the to be applied electrical energy can be derived. The electrical energy may be quantized in the form of current and/or voltage applied to the at least one light-emitting device. The electric energy can thereby also be defined as a difference to the currently applied electrical energy. The currently applied electrical energy has a defined associated target color point, however when the temperature of the at least one light-emitting device changes, then also the electrical energy to be applied to the at least one light-emitting device needs to be changed, in order to reach or to uphold the target color point. This difference in electrical energy needed to reach or to uphold the target color point can be determined and subsequently can be provided to the at least one light-emitting device to operate the at least one-light emitting device correspondingly.

It can also be said, by a known correlation between temperature, electrical energy and color emitted or to be emitted a linear equation system is given, which can be solved for the electrical energy, when the at least other two variables, i.e. temperature and color is known. One of which, namely the color, is given by the target color point, the other one, namely the temperature, can be determined.

The temperature of the at least one light-emitting device may thereby be determined by a temperature sensor. For example, a semiconductor temperature sensor could be attached to each of the at least one light-emitting device. In this case it could be said that the temperature is indirectly measured, since a heat transfer between the at least one light-emitting device and the sensor needs to take place.

The temperature could however also be directly determined. Thereby, each of the at least one light-emitting devices may be operated in on-intervals and off-intervals, hence periods of time in which more or less electrical energy is provided to each of the light-emitting devices. The off-interval may include at least one sensing interval during which the electrical energy across the light-emitting device may be measured, which may then be mathematically correlated with the temperature of the at least one light-emitting device. In general, the temperature of a light-emitting device is a function of the electrical energy provided to the at least one light-emitting device. If no electrical energy is provided to the light-emitting device, the temperature of the light-emitting device is given by the ambient temperature. In general, if a voltage, U, and a current, I, are applied to a light-emitting device, the disposed power, P, equals P=U*I. The electrical energy, E, disposed in the light-emitting device equals the integral of the power, P(t), over time, t. A certain fraction of the disposed electrical energy, E, is dissipated in the light-emitting device and not emitted in the form of light energy. This leads to heating of the light-emitting device up to a temperature, T, which depends, among other material parameters, on the voltage, U, and the current, I. Thus, it could be said that the temperature, T, of the light-emitting device is a function T(U, I), wherein U and I are the voltage and current applied across the light-emitting device, respectively. Hence, the function T(U, I) may be used to determine at least one temperature value, T, if at least one voltage, U, and one current, I, measured across the light-emitting device are given. The temperature increase due to electrical power may be referred to as “over temperature”, which comes on top of the ambient temperature. Hence, the function T(U, I), respectively the inverse of that function will give the ambient temperature or ambient temperature plus over temperature dependence if there is/was a temperature increase because of electrical power. Furthermore, any light-emitting device may be characterized by a temperature-dependent resistance, R(T). For example, the resistance of a filament of a light bulb increases with increasing temperature. In contrast, the resistance of a light-emitting diode decreases with increasing temperature. Hence, if a temperature-dependent resistance, R(T), is given, voltage, U, and current, I, across the light-emitting device are related by R(T)=U/I and one of voltage, U, or current, I, may be substituted in the function T(U, I) for the temperature, T. For example, if the current, I, is substituted, a function T(U) results for the temperature, T, of the light-emitting device as a function of the voltage, U, supplied across the light-emitting device. If the voltage, U, is substituted, this yields a temperature T(I) as a function of the current, I, passed across the light-emitting device. Thus, using the function T(U), a temperature value, T, may be determined for each of the at least one measured voltage, U, across the light-emitting device. Likewise, the function T(I) may be used to determine a temperature value, T, for each of the at least one measured current, I, across the light-emitting device. It could also be said that the temperature, T, of the light-emitting device may be determined by evaluating one of the functions T(U, I), T(U) and/or T(I). Evaluating these functions may make use of numerical approximation of calibration measurements. This allows to determine the temperature of the at least one light-emitting device in a direct way without the need of a sensor.

The temperature determination and as such the determination of the electrical energy necessary to be provided to the at least one light-emitting device can be performed continuously, periodically or nonperiodically. How often the temperature and as such the needed electrical energy is determined also dependents on the expected temperature profile of the at least one light-emitting device. If a light-emitting device has a more agile temperature responsiveness, the determination needs to be performed more often than if the light-emitting device has a less agile temperature responsiveness. Agile thereby characterizes how much degrees the temperature changes over time. The agility may be determined by a heat transfer or a heat capacitance of the light-emitting device. A light-emitting device is more agile when a high amount of temperature degrees changes in less amount of time as compared to a non-agile light-emitting device. It can also be said that light-emitting devices have different energy dissipating profiles and as such different temperature profiles. Dependent on these profiles it is then more often or less often necessary to determine the temperature and the respective electrical energy to reach the respective target color point.

However, it is also encompassed that the temperature determination may be timewise decoupled from the electrical energy determination. Hence, the temperature of the at least one light-emitting device may be determined more often than the electrical energy. For example, the electrical energy necessary to reach the target color point may only be determined if the temperature exceeds a threshold. This threshold may be associated with an acceptable deviation from the target color point, such that only if the respective deviation is exceeded, a new determination for the electrical energy necessary to reach the target color point is performed. The temperature determination may however also always be coupled with the electrical energy determination.

It may also be encompassed that the temperature and electrical energy determination is performed in an initial phase, e.g. when the light-emitting device is switched on, more often than at later times of operation, during which the temperature of the at least one light-emitting device may change less frequently as compared to the initial phase.

The determination of the electrical energy can be performed in a way that a target color point is reached, e.g. when the at least one light-emitting device is just switched on. In this case, it needs to be determined how much electrical energy needs to be provided to the at least one light-emitting device to reach the target color point. The same may also be true if the color point itself changes. In addition, or alternatively, the determination can also be performed to uphold a given target color point, e.g. when the temperature changes. It is clear that the determination step can therefore be performed iteratively.

In any case, once the electrical energy necessary to reach or uphold the target color point is determined, the method comprises operating the at least one light-emitting device based on the determined operating electrical energy. The operating can comprise the provision of the respective electrical energy to the at least one light-emitting device. The operating may additionally or alternatively comprise controlling the electrical energy which is provided to the at least one light-emitting device by a power source. Providing electrical energy to the at least one light emitting device may also be referred to as driving the at least one light-emitting device.

Hence, by utilizing the correlation between the temperature of the at least one light-emitting device and the color the respective light-emitting device is emitting at a certain electrical energy level, the effect the temperature has on the color emitted by the at least one light-emitting device can be compensated due to the adaptation of the electrical energy provided to the light-emitting device.

In a preferred aspect of the invention, the target color point may comprise a Tristimulus value for the light emitted by the at least one light-emitting device. The Tristimulus values may be given by a red part value X, a blue part value Z and a luminance value Y. As already stated, the Tristimulus values may relate to the RGB color space. As such, the target color point can also be given by RGB values. Thereby, one value may be given for the red-part of the RGB color space, one for the green-part of the RGB color space and one for the blue-part of the RGB color space. If another quantization of the perception of color is used, the target color point can also include other values. In one example the target color point may include just one value for the target wavelength, A, the respective at least one light-emitting device shall emit. The method may also comprise the transformation of the target color point from one color space model to another if necessary.

In another preferred aspect, the at least one temperature value is occurring locally at the at least one light-emitting device and is also directly measured at the at least one light-emitting device. Locally thereby refers to the fact that the temperature is determined for the actually point where it the energy dissipation leads to the heat development. The direct measurement mitigates the need for a sensor which only can measure the heat transferred from the light-emitting device to the sensor, but not the direct temperature of the light-emitting device. The direct measurement can be performed for example during at least one sensing interval during an off-interval of operating the at least one light-emitting device. With the temperature value it is then possible to determine the electric energy which needs to be applied to the at least one light-emitting device to uphold or reach the target color point.

In another preferred aspect, the determining further comprises determining a contribution of each of the at least one light-emitting device to the received target color point. Each light-emitting device may correspond to one value of the Tristimulus value in the RGB color space. For example, one light-emitting device may relate to the red component of the RGB color space, one light-emitting device may relate to the green component of the RGB color space and one light-emitting device may relate to the blue component of the RGB color space. Alternatively, also the red, green and blue light components emitted from one light-emitting device may contribute to the Tristimulus value in the same way as three individual light-emitting devices would. For simplicity, in the following if not explicitly stated otherwise, when it is referred to a plurality of light-emitting devices which emit light with a specific color, then it is also contemplated that one light-emitting device may emit with respective light-emitting components, the respective specific color.

When the light-emitting devices emit the different color, like red, green and blue, then also each of the light-emitting devices may have a different contribution to the target color point. In order to have a refined temperature compensation, each of the light-emitting devices may be operated separately. Hence, each light-emitting device may independently be compensated based on its own temperature and its contribution to the target color point. Thereby, it should be contemplated that even if for exemplary purposes only three light-emitting devices corresponding to the respective RGB colors are described, also several light-emitting devices can correspond to the respective colors. As already stated above, it is also contemplated that one light-emitting device is capable of emitting light for all three RGB colors either at the same time or intermittently and that in this case each light-emitting component of the light-emitting device can contribute to the target color point and can be compensated accordingly. In this case however, it may be possible that the same temperature for all light-emitting components is taken into account, at least when they are located sufficiently close together such that the temperature is representative for all light-emitting components. It could also be said that each of the RGB components emitted by one or more than one light-emitting devices corresponds to an individual color state of the light-emitting device.

The contribution of each of the light-emitting devices may dependent on a respective peak electrical energy with which each of the respective light-emitting devices is operated. Thereby, the peak electrical energy may be the highest electrical energy over time a light-emitting device can be operated with.

Furthermore, the contribution of each of the light-emitting devices may depend on the at least one temperature value of each of the respective light-emitting devices.

In order to determine the operating electrical energy for each of the at least one light-emitting devices, the respective contributions of each of the at least one light-emitting devices may be stored as a function of temperature values of each of the respective light-emitting devices in a look-up table, wherein the look-up table may then be used for determining the operating electrical energy of each of the at least one light-emitting devices to reach or uphold the target color point. Hence, during an initial test phase, setup phase, or in the laboratory, the respective contributions can be evaluated such that during normal operation of the at least one light-emitting device the respective electrical energy for reaching or upholding a target color point can be taken from the look-up table in correspondence with the respective temperatures.

Furthermore, the respective contributions of each of the at least one light-emitting devices at a standard temperature may be stored in a vector. The vector may be used for determining the operating electrical energy of each of the at least one light-emitting devices. Thereby the standard temperature may be a standardized temperature, which is likely to be exhibited by the at least one light-emitting device. For example, the standard temperature may be about 25° C. However, this shall not be limiting thereto. Any temperature may be used and shall only be used as reference. Furthermore, the temperature dependency of the contribution may be modelled by applying a respective relative deviation to the stored contribution at the standard temperature. Thereby, each relative deviation may depend on the at least one temperature value of the respective light-emitting device. Hence, if the current temperature of the light-emitting device is known, the deviation from the reference temperature can be used to determine the deviation of the electrical energy needed to be applied to the at least one light-emitting device to compensate for the respective temperature influence on the respective light-emitting device in order to reach or uphold the given target color point.

In one aspect, the at least one light-emitting device comprises one or several light-emitting components. If the light emitting device comprises only one light-emitting component, then this light-emitting component may be configured to emit light at different wavelengths. If a light-emitting device comprises several light-emitting components, then each of the light-emitting components may emit light at a specific wavelength, such that the superposition of the different light-emitting components yields to the wavelength emitted by the light-emitting device. It shall be contemplated that when it is referred to a light-emitting device both of the aforementioned implementations are encompassed. The light-emitting component may be a light-emitting diode. If several light-emitting components are used in a light-emitting device, then these light-emitting components may be a predominantly red light-emitting diode (700 nm), predominantly green light-emitting diode (546.1 nm) and a predominantly blue light-emitting diode (435.8 nm), in this case it can also be said that the light-emitting device is as RGB light-emitting device. The light emitted from such an RGB light-emitting device is the superposition of the light emitted from the three different light-emitting diodes. However, also each of the light-emitting component, i.e. the light emitting diodes, can be regarded as one light-emitting device, namely one which just comprises one light emitting component.

Although the aspects of the method are described in separate paragraphs it shall be contemplated that all of the aspects of the method are combinable, and no aspects rules out the other. Hence, each of the aspects described herein are separately or together be combinable with the general aspect of the described method.

The need for temperature compensation is also fulfilled by an apparatus for temperature compensation of at least one light-emitting device. The apparatus comprises a receiving unit for receiving a target color point for light emitted by the at least one light-emitting device, a determination unit for determining an operating electrical energy of the at least one light-emitting device based on a correlation of at least one temperature value of the at least one light-emitting device with the received target color point and an operating unit for operating the at least one light-emitting device based on the determined operating electrical energy.

The light-emitting device can be a device which emits light at a specific wavelength, as described above. Thereby, the light-emitting device can for example comprise one or several light-emitting components, wherein the light-emitting components may be light-emitting diodes.

The receiving unit and the determination unit may be implemented in hardware or software. For example, a microcontroller may be used, which receives the target color point and performs by ease of employing software the respective determination.

The unit for operating the at least one light-emitting device may be a power source, which is controllable by the output of the determination unit, and which provides the light-emitting device with electrical energy. The power source can thereby be a voltage or current source.

The different units may also all be implemented together in an integrated circuit, which is employed together with the at least one light-emitting device or is separate therefrom. An integrated circuit (also known as an IC, a chip, or a microchip) is a set of electronic circuits on one small piece of semiconductor material.

### BRIEF DESCRIPTION OF THE DRAWINGS

In the following further advantages and details of the invention will become apparent from the detailed description of the figures. It shall be understood that none of the elements shown shall be regarded to be limiting and any software/hardware element or module which performs the respective described functionality shall be encompassed.

FIG. 1 shows a flow diagram of a method according to the invention;

FIG. 2a shows a schematic view of light-emission of a light-emitting device at a first temperature according to the invention;

FIG. 2b shows a schematic view of light-emission of a light-emitting device at a second temperature according to the invention;

FIG. 2c shows a schematic view of light-emission of a light-emitting device at a third temperature according to the invention;

FIG. 3 shows a schematic view of an array of light-emitting devices, each light-emitting device comprises three light-emitting components; and

FIG. 4 shows an exemplary block diagram of the electronic device according to the invention.

### DETAILED DESCRIPTION

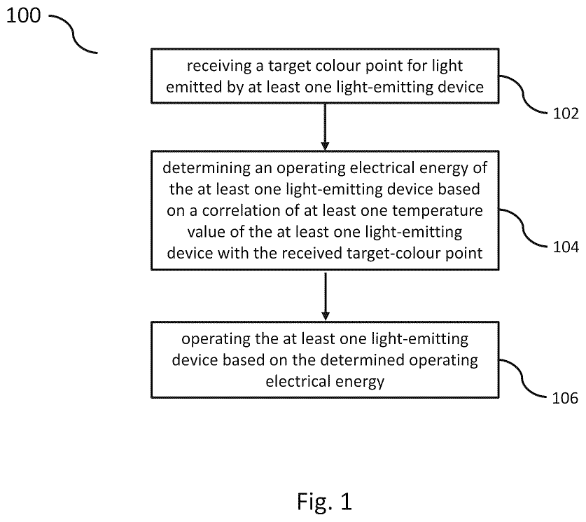

FIG. 1 shows a method 100 for temperature compensation according to the invention. The method 100 includes the steps of receiving 102 a target color point for light emitted by at least one light-emitting device, determining 104 an operating electrical energy of the at least one light-emitting device based on a correlation of at least one temperature value of the at least one light-emitting device with the received target-color point, and operating 106 the at least one light-emitting device based on the determined operating electrical energy.

Method 100 for temperature compensation may be performed by an electronic device according to the invention. For example, the target color point for light emitted by the at least one light-emitting device may be received 102 by a reception unit of the electronic device. An operating electrical energy determination unit of the electronic device may determine 104 an operating electrical energy of the at least one light-emitting device. This determining may be based on a correlation of at least one temperature value of the at least one light-emitting device with the target-color point received 102 from the reception unit. The at least one temperature value may also be received from the reception unit. An operating unit may operate 106 the at least one light-emitting device based on the determined operating electrical energy.

It is evident that at least the step 104 of determining an operating electrical energy of the at least one light-emitting device can be performed iteratively, without the need for the other steps also to be performed. Hence, the determination step 104 can be performed more often than steps 102 and 106.

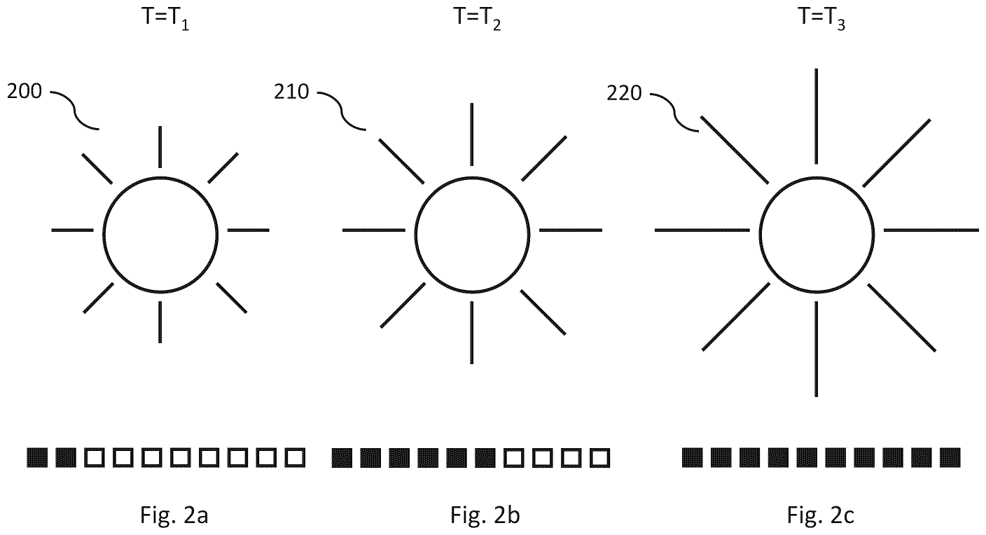

FIG. 2a depicts a schematic view of light-emission of a light-emitting device at a first temperature according to the invention. At a given temperature and a given operating electrical energy, the light-emitting device emits light of a given brightness and color.

Color is referred herein as a photometric quantity of the light-emitting device. The perceived color is fully described by three Tristimulus values, X, Y and Z. The Tristimulus values X, Y, Z depend on the temperature, T, of the light-emitting device and on the operating electrical energy supplied to the light-emitting device. The operating electrical energy may be given by an operating current, I, of the light-emitting device. The dependency of the Tristimulus values X, Y, Z on the operating current, I, may be linear while the dependency of the Tristimulus values X, Y, Z on the temperature, T, may in general be non-linear. Hence, in FIG. 2a, at temperature T=T₁, the light-emitting device emits light with a color and brightness that is characterized by temperature-dependent Tristimulus values, X(T), Y(T), Z(T), and a linear factor including the operating current, I, and the peak operating current, Iₘₐₓ:

$$X = \frac{I}{{I}_{max}} * X ( T = {T}_{1} )$$

$$Y = \frac{I}{{I}_{max}} * Y ( T = {T}_{1} )$$

$$Z = \frac{I}{{I}_{max}} * Z ( T = {T}_{1} )$$

The temperature-dependent Tristimulus values X(T), Y(T), Z(T) describe the temperature dependency of the Tristimulus values X, Y, Z normalized to the linear dependency on the operating current, I. It could also be said that the temperature-dependent Tristimulus values X(T), Y(T), Z(T) are scaled by the relative current strength I/Iₘₐₓ to yield the Tristimulus values X, Y, Z.

FIGS. 2b and 2c show the same light-emitting device at different temperatures T₂ and T₃, which are different to T₁ and increasing, i.e. T₁<T₂<T₃. In the here shown embodiment example, the brightness increases, which is indicated by the increasing radial sunbeams as wells as the current provided to the light emitting device is increased, which is indicated by the increasing bars below the sunbeams. In FIG. 2c the maximum of the brightness, temperature and current provision to the light-emitting device is reached. As shown here, in order to hold or increase the brightness when the temperature is increasing, a higher electrical power is needed. If the same electrical power would be provided at the three different temperatures, the brightness would decrease, since the brightness decreases with increasing temperature. To compensate this, the electrical energy needs to be increased.

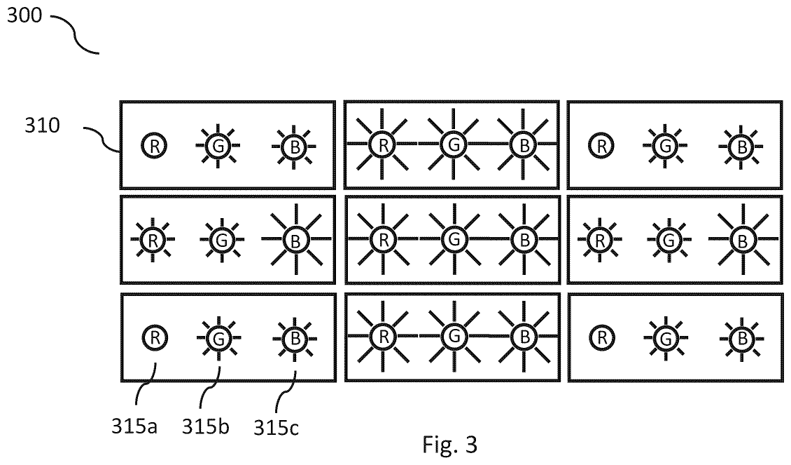

FIG. 3 shows a schematic view of an array 300 of light-emitting devices 310. In the here shown embodiment example, each light-emitting device 310 comprises three light-emitting components 315a, 315b, 315c. Thereby, light-emitting component 315a emits predominantly red light, which is indicated by an “R”, light-emitting component 315b emits predominantly green light, which is indicated by a “G”, light-emitting component 315c emits predominantly blue light, which is indicated by an “B”. Thereby, the light-emitting components may be light-emitting diodes, which each emit a light, which has a wavelength, which closely corresponds with their predominant emitted color, e.g. 700 nm for red, 546.1 nm for green, and 435.8 nm for blue. Although specific wavelengths are named here, it shall be contemplated that this is only done for exemplary purposes and shall not be regarded to be limiting. In the here shown embodiment, the color of the light emitted by each light-emitting device is a superposition of the light emitted from the respective light-emitting components 315a, 315b, 315c. Although the light-emitting devices 310 in the here shown embodiment use three light-emitting components 315a, 315b, 315c, it shall also be contemplated that each light-emitting device 310 may comprise more or less light-emitting components. It shall also be contemplated that each light-emitting device 310 may comprise only one light-emitting component. In this case, it can also be said that the light-emitting device 310 is the light-emitting component. Furthermore, it shall be contemplated that each light-emitting device 310 has a light-emitting component, which is capable of emitting light of more than one specific wavelength.

In the here shown embodiment the brightness of the respective light-emitting components is also indicated by the lengths of the respective sunbeams. The length of the beams thereby indicates the brightness. The light-emitting devices 310 in the middle of the array 300 have the highest brightness. Also, in the middle of the array each of the respective light-emitting components 315a, 315b, 315c have the same brightness. Here for example white light is emitted, since the superposition of the red, green, and blue lights lead to white light It is however contemplated that also different colors may be achieved by the superposition of light emitted from the respective light-emitting components 315a, 315b, 315c. At the edges of the array 300, the light-emitting components 315a, 315b, 315c have larger blue portions, which leads to emitted light with wavelength more shifted to the blue spectrum. Such an array and for shown configuration of the brightness of the light-emitting components 315a, 315b, 315c may for example be used in headlights of an automobile. For such applications, but also in other implementations, it is imperative that despite the changing temperature of the light-emitting devices 310 or even the light-emitting components 315a, 315b, 315c, the emitted color of the array 300 does not change. For this the temperature compensation as described herein is necessary and may be applied to either each of the light-emitting devices 310 of the array 300 or even to each of the light-emitting components 315a, 315b, 315c of the array 300. It can thereby be said, that the temperature of each of the light-emitting devices 310 or even of each of the light-emitting components 315a, 315b, 315c is taken into account and the electrical energy provided to the respective light-emitting device 310 or light-emitting component 315a, 315b, 315c is adjusted accordingly to achieve the respective target color point or to hold the respective target color point. It is clear that the target color point can be defined for each light-emitting device 310 or even each light-emitting component 315a, 315b, 315 c separately.

To stay in the example described in context of FIGS. 2a to 2c, each of the light-emitting components 315a, 315b and 315c can be indexed in the equations above. Hence, an index, i, could be added to the individual Tristimulus values, Xᵢ, Yᵢ, Zᵢ and to the operating electrical energies, e.g., to the operating electrical currents, Iᵢ, and the peak operating electrical currents, Iᵢₘₐₓ.

Thus, it could be said that the contribution of a light-emitting components identified by an index, i, operated with an operating current, Iᵢ, at peak operating current, Iᵢₘₐₓ, and temperature, Tᵢ, to the target Tristimulus value Xₜ, Yₜ, Zₜ of the resulting light beam is given by:

$${X}_{i} = \frac{{I}_{i}}{{I}_{imax}} * {X}_{i} ( T = {T}_{i} )$$

$${Y}_{i} = \frac{{I}_{i}}{{I}_{imax}} * {Y}_{i} ( T = {T}_{i} )$$

$${Z}_{i} = \frac{{I}_{i}}{{I}_{imax}} * {Z}_{i} ( T = {T}_{i} )$$

Thus, if the light of the three light-emitting components 315a, 315b, and 315c would be mixed, the target Tristimulus values Xₜ, Yₜ, Zₜ of the resulting light would be given by:

$${X}_{t} = \frac{{I}_{1}}{{I}_{1 max}} * {X}_{1} ( T = {T}_{1} ) + \frac{{I}_{2}}{{I}_{2 max}} * {X}_{2} ( T = {T}_{2} ) + \frac{{I}_{3}}{{I}_{3 max}} * {X}_{3} ( T = {T}_{3} )$$

$${Y}_{t} = \frac{{I}_{1}}{{I}_{1 max}} * {Y}_{1} ( T = {T}_{1} ) + \frac{{I}_{2}}{{I}_{2 max}} * {Y}_{2} ( T = {T}_{2} ) + \frac{{I}_{3}}{{I}_{3 max}} * {Y}_{3} ( T = {T}_{3} )$$

$${Z}_{t} = \frac{{I}_{1}}{{I}_{1 max}} * {Z}_{1} ( T = {T}_{1} ) + \frac{{I}_{2}}{{I}_{2 max}} * {Z}_{2} ( T = {T}_{2} ) + \frac{{I}_{3}}{{I}_{3 max}} * {Z}_{3} ( T = {T}_{3} )$$

Thereby, I₁, I₂ and I₃ are the operating currents of the light-emitting components, I₁ₘₐₓ, I₂ₘₐₓ and I₃ₘₐₓ are the peak operating currents of the light-emitting components, and T₁, T₂ and T₃ are the respective temperatures of the light-emitting components. Xᵢ (T), Yᵢ (T) and Zᵢ (T) are the temperature-dependent Tristimulus values for the three light-emitting components index by i=1, 2 and 3.

The peak operating currents of the light-emitting components, namely the parameters I₁ₘₐₓ, I₂ₘₐₓ and I₃ₘₐₓ, could be fixed in order to avoid too high operating currents, which could risk damage of the light-emitting components due to, e.g., overheating. The remaining temperature-dependent Tristimulus values for the three light-emitting components, Xᵢ (T), Yᵢ (T) and Zᵢ (T), are given and constitute response functions of the light-emitting components 315a, 315b and 315c to their individual temperatures. It could also be said that temperature-dependent Tristimulus values for the three light-emitting components, Xᵢ (T), Yᵢ (T) and Zᵢ (T), are defined by the material parameters of the three light-emitting components 315a, 315b, 315c. Hence, if a target Tristimulus value Xₜ, Yₜ, Z of a resulting light beam of the light-emitting device 310 is given, the above-mentioned equation system must be solved for the operating currents, l₁, l₂ and l₃. Before solving for the operating currents, the coefficients of the equation system need to be calculated from the known peak operating currents, l₁ₘₐₓ, l₂ₘₐₓ and l₃ₘₐₓ, and temperatures, T₁, T₂ and T₃, of the light-emitting devices.

The temperature-dependent Tristimulus values for the three light-emitting components, Xᵢ (T), Yᵢ(T) and Zᵢ(T), constitute a temperature-dependent Tristimulus matrix X(T)=[Xᵢ(T=Tᵢ); Yᵢ (T=Tᵢ); Zᵢ (T=Tᵢ)], with columns indexed by the index i and a dependency on a vector of temperatures T=[T₁, T₂, T₃]. Thus, it might be said that the columns of the Tristimulus matrix are each a function of a different temperature, Tᵢ. For example, column i of X(T) depends only on Tᵢ. The rows of the Tristimulus matrix X(T) corresponds to the different temperature dependent color space dimensions X, Y and Z. The temperature-dependent Tristimulus matrix X(T) could be stored as a look-up table or using a set of approximating functions. However, the temperature-dependent Tristimulus matrix X(T) might also be simplified by approximations.

One simplifying approximation of the temperature-dependent Tristimulus matrix X(T) is that the matrix X(T) is only evaluated at a reference temperature, T_{ref}, and not at arbitrary temperatures, T. In other words, all temperatures of all light-emitting components are set to the reference temperature, Tᵢ=T_{ref}. In the example of three-light emitting devices as above, a Tristimulus matrix X_{ref} at reference temperature T_{ref} is obtained, X_{ref}=X(T=[T_{ref}, T_{ref}, T_{ref}]). In many cases, the temperature-dependence of the temperature-dependent Tristimulus matrix X(T) can be modelled as a linear scaling with respect to the reference temperature, wherein the linear scaling is a function of the deviation of the temperatures T from the reference temperature T_{ref}. Thus, in this linear scaling approximation, the temperature-dependent Tristimulus matrix X(T) is given by:

$${X}_{i} ( {T}_{i} ) = {X}_{i} ( T = {T}_{ref} ) * {δ}_{i}^{X} ( {T}_{i} - {T}_{ref} )$$

$${Y}_{i} ( {T}_{i} ) = {Y}_{i} ( T = {T}_{ref} ) * {δ}_{i}^{Y} ( {T}_{i} - {T}_{ref} )$$

$${Z}_{i} ( {T}_{i} ) = {Z}_{i} ( T = {T}_{ref} ) * {δ}_{i}^{Z} ( {T}_{i} - {T}_{ref} )$$

Thereby, δᵢ^{X}(Tᵢ), δᵢ^{Y}(Tᵢ), δᵢ^{Z}(Tᵢ) are the relative deviations of the temperature-dependent Tristumulus values X, Y, Z for light-emitting component i at temperature Tᵢ. It could also be said that, in the linear approximation, the temperature-dependent Tristimulus matrix X(T) is given by the dyadic product of the Tristimulus matrix X_{ref} at reference temperature T_{ref} and the matrix of relative deviations [δᵢ^{X}(Tᵢ), δᵢ^{Y}(Tᵢ), δᵢ^{Z}(Tᵢ)].

In a further simplifying approximation, the relative deviations δᵢ^{X}(Tᵢ), δᵢ^{Y}(Tᵢ), δᵢ^{Z}(Tᵢ) may be assumed to be independent of the type of the light-emitting component. In this case, the relative deviations can be assumed to be a three-dimensional vector δ(Tᵢ)=[δ^{X}(Tᵢ), δ^{Y}(Tᵢ), δ^{Z}(Tᵢ)]. It could also be said that, in this approximation, the individual temperature of each light-emitting component, Tᵢ, enters the relative deviations, but the temperature-dependence of the relative deviations itself is generic and uncorrelated to the specific type of light-emitting component. This has the advantage that only three functions of temperature must be stored in order to model the temperature-dependency of the temperature-dependent Tristimulus values of all light-emitting components 315a, 315b, and 315c.

Furthermore, the above approximation may also be further simplified by

$${X}_{i} ( {T}_{i} ) = {X}_{i} ( T = {T}_{ref} ) + ( {T}_{i , X} )$$

$${Y}_{i} ( {T}_{i} ) = {Y}_{i} ( T = {T}_{ref} ) + ( {T}_{i , Y} )$$

$${Z}_{i} ( {T}_{i} ) = {Z}_{i} ( T = {T}_{ref} ) + ( {T}_{i , Z} )$$

where T_{i,X} describes the change of Xᵢ over temperature, where T_{i,Y} describes the change of Yᵢ over temperature and where T_{i,Z} describes the change of Zᵢ over temperature.

Hence, if a target color point is given, for example by specific Tristimulus values, the aforementioned dependency can be used to determine the electrical energy, for example the current, which needs to be provided to the respective light-emitting components 315a, 315b and 315 c to achieve the respective target color point in dependency from the respective temperature of the individual light-emitting components 315a, 315b and 315 c. This allows a very refined temperature compensation, since it is accounted for each color contribution separately. In case the light emitting device 310 comprises three light-emitting components 315a, 315b and 315c, which predominantly emit red, green and blue light and refer to the RGB color space, it can also be said, it is accounted for each of the colors individually, since each temperature of the respective light-emitting components 315a, 315b and 315c is factored in the electrical energy determination.

Although in the here shown embodiment example, the light-emitting devices 310 have three light-emitting components 315a, 315b and 315 c, it is contemplated that each of the light-emitting devices 310 comprises more or less light emitting devices. The aforementioned equations then change accordingly. However, for simplicity reasons only the most common implementation with three light-emitting components 315a, 315b and 315 c is described, which shall however not mean that the disclosure is limited to the respective most common case.

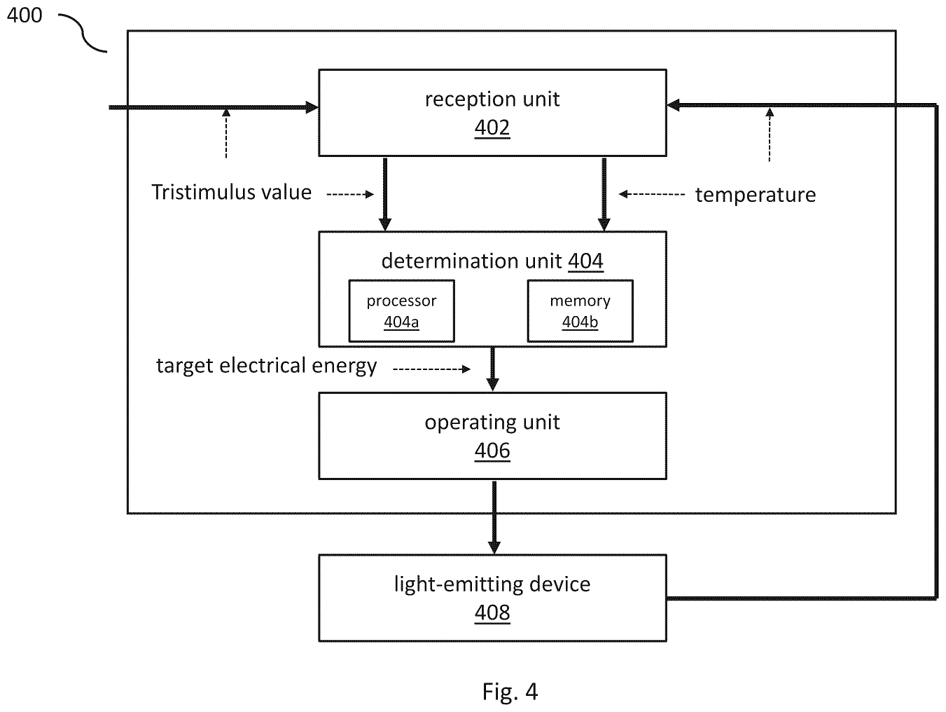

FIG. 4 shows an exemplary block diagram of the electronic device 400 according to the invention and a light-emitting device 408. At least parts of the electronic device 400 may be implemented in hardware and/or software and may be implemented in a microcontroller and/or an integrated circuit. The light-emitting device 408 may be an LED. The light-emitting device 408 may comprise three light-emitting components (here not shown), wherein one light-emitting component may emit light predominantly in the red spectrum, one may emit light predominantly in the green spectrum and one may emit light predominantly in the blue spectrum. The light-emitting device 408 shall however not be limited thereto.

The electronic device 400 may comprise a reception unit 402, which receives a target color point value, in the here shown embodiment example, the target color point is given by a Tristimulus value. This value may be received from a controller (here not shown) different to the electronic device 400 or may already be pre-programmed into the electronic device 400. For example, a specific target color point may be associated with a specific function of the at least one light-emitting device has to fulfil. For example, if the light-emitting device is part of a rear-light array of light-emitting devices, a target color point in the orange spectrum may be used as indicator light, whereas a target color point in the red spectrum may be used as break light, a target color point in the white spectrum may be used to indicate a reverse motion. Furthermore, it may also be possible to regulate the intensity of an LED arrays over temperature, e.g. for theatre spotlights. These shall however only be used as examples and shall not be regarded to be limiting. Furthermore, in the here shown embodiment example, the reception unit 402 also receives the temperature of the respective light-emitting device 408. This temperature may either be measured by a sensor or derived from a sensing interval during an off-interval of the light-emitting device 408. The reception unit 402 passes the target color point as well as the current temperature of the light-emitting device 408 to a determination unit 404.

The determination unit 404 may be a processor 404a or a hardwired logic, which takes the target color point as well as the temperature as input to determine an output, wherein the output is the target electrical energy with which the light-emitting device 408 needs to be operated to reach or uphold the target color point dependent upon the current temperature of the light-emitting device 408. Thereby, the determination unit 404 may have stored in a memory 404b a look-up table in which respective approximations are stored to determine the electrical energy adjustment needed for the light-emitting device 408 to hold or reach the respective target color point. Thereby, the respective approximations are the ones as described in context of FIGS. 2a to 2c, and 3. For example, the look-up table may comprise standard deviation for the respective color components from a reference temperature. For example, at the reference temperature, no adjustment for the electrical energy is needed. Here the standard deviation may indicate nor deviation from the standard applied electrical energy. A deviation in temperature may indicate that also a certain percentage, increase or decrease, of the electrical energy is necessary to uphold or reach the respective target color point. This will allow to quickly or nearly in real time to determine the electrical energy needed, or respectively the deviation in the electrical energy need.

Once the target electrical energy is determined, this information is passed from the determination unit 404 to the operating unit 406. The operating unit 406 can be a controller of a power source or the power source itself, which provides the electrical energy to the light-emitting device 408. The target electrical energy as passed from the determination unit 404 to the operating unit 406 may be an absolute value or a differential value. An absolute value may specify how much electrical energy needs to be provided to the light-emitting device 408. A differential value may specify the difference between the currently supplied electrical energy and the to be supplied energy. The operating unit 406 then provides the respective electrical energy to the light-emitting device 408 such that the light-emitting device 408 will still reach or uphold the respective target color point in dependency on its current temperature. The electrical energy may be quantized in voltage or current to be supplied to the light-emitting device 408.

Although in the here shown embodiment only one light-emitting device 408 is shown, it is contemplated that also a plurality of light-emitting devices can be served by the same electronic device 400. Alternatively, also each light-emitting device 408 may comprise its own electronic device 400. Furthermore, it shall also be contemplated that each light-emitting device 408 comprises at least one light-emitting component. The temperature information provided to the reception unit 402 can thereby include information for each of the light-emitting devices 408 or for each of the light-emitting components, such that a refined temperature compensation of a light-emitting component level is possible.

Although specific hardware elements are described herein, this shall not be understood to be limiting and the invention shall also encompass other hardware elements, which are able to provide the same functionality as the ones described herein.

1. A method for temperature compensation, the method comprising:
receiving a target color point for light emitted by at least one light-emitting device;
determining an operating electrical energy of the at least one light-emitting device based on a correlation of at least one temperature value of the at least one light-emitting device with the received target-color point; and
operating the at least one light-emitting device based on the determined operating electrical energy.

2. The method according to claim 1, wherein the target color point comprises a Tristimulus value for the light emitted by the at least one light-emitting device.

3. The method according to claim 1, wherein the at least one temperature value is occurring locally at the at least one light-emitting device.

4. The method according to claim 1, wherein the determining further comprises:
determining a contribution of each of the at least one light-emitting device to the received target color point.

5. The method according to claim 4, wherein the contribution depends on a respective peak electrical energy with which each of the respective light-emitting devices is operated.

6. The method according to claim 4, wherein the contribution depends on the at least one temperature value of each of the respective light-emitting devices.

7. The method according to claim 4, further comprising:
storing the contribution as a function of temperature values of each of the respective light-emitting devices in a look-up table, wherein the look-up table is used for determining the operating electrical energy of each of the at least one light-emitting devices.

8. The method according to claim 4, further comprising:
storing the contribution at a standard temperature of each of the respective light-emitting devices in a vector, wherein the vector is used for determining the operating electrical energy of each of the at least one light-emitting devices.

9. The method according to claim 8, further comprising:
modelling the temperature dependency of the contribution by applying a respective relative deviation to the stored contribution at the standard temperature.

10. The method of claim 9, wherein the standard temperature is 25° C.

11. The method according to claim 9, wherein each relative deviation depends on the at least one temperature value of the respective light-emitting device.

12. The method according to claim 1, wherein the correlation is constituted by a linear system of equations.

13. The method according to claim 1, wherein the received target color point comprises a brightness of the light emitted by the at least one light-emitting device.

14. The method according to claim 1, wherein the at least one light-emitting device comprises at least of a red light-emitting diode, LED, a green light-emitting diode, LED, and a blue light-emitting diode, LED.

15. An apparatus for temperature compensation of at least one light-emitting device, the apparatus comprising:
a receiving unit for receiving a target color point for light emitted by the at least one light-emitting device;
a determination unit for determining an operating electrical energy of the at least one light-emitting device based on a correlation of at least one temperature value of the at least one light-emitting device with the received target color point; and
an operating unit for operating the at least one light-emitting device based on the determined operating electrical energy.
